(19) United States
(12) Patent Application Publication
(10) Pub. No.: US 2011/0206985 A1
(43) Pub. Date: Aug. 25, 2011

(54) LITHIUM SECONDARY BATTERY AND METHOD FOR MANUFACTURING THE SAME

(75) Inventors: Shosaku ISHIHARA, Chigasaki (JP); Hiroshi Kikuchi, Zushi (JP)

(73) Assignee: HITACHI, LTD.

(21) Appl. No.: 12/960,139

(22) Filed: Dec. 3, 2010

(30) Foreign Application Priority Data
Feb. 23, 2010 (JP) 2010-036786

(51) Int. Cl. H01M 4/24; H01M 4/26; H01M 10/04

(52) U.S. Cl. 429/209; 29/623.5; 29/623.1

(57) ABSTRACT

Although a larger battery and higher filling of an active material are essential to produce a high capacity battery, a longer time is required for permeation of an electrolytic solution at this case. An electrode membrane formed on the surface of a electrode is configured as an electrode membrane structure combining a mixture layer in which density of an active material is high while the electrolytic solution is difficult to permeate because of small void size and a mixture layer in which an electrolytic solution is easy to permeate while density of an active material is low because of large void size. Permeation time of an electrolytic solution can be reduced in a manner that the mixture layer having large void size acts as a supply path for the electrolytic solution.

### BACKGROUND OF THE INVENTION

1. Field of the Invention

The present invention relates to a lithium secondary battery and a method for manufacturing the same.

2. Description of the Related Arts

From a viewpoint of environmental protection and energy conservation, a hybrid electric car, which uses an engine and a motor as power sources at the same time, or an electric car, which only uses a motor as a power source, has been developed and productized. In addition, a hybrid fuel cell car, which uses a fuel cell instead of an engine and will be used in future, has been actively developed. As energy sources for the hybrid electric car and the hybrid fuel cell car, secondary batteries, which can be repeatedly charged and discharged, are essential technology.

Among them, a lithium secondary battery is a prevalent battery because its operating voltage is high and high energy output is easily obtained. Therefore, the lithium secondary battery is a battery whose importance as power sources for the hybrid electric car and the hybrid fuel cell car increases more and more in years to come. Similarly, the lithium secondary battery has increased its importance in applications for electric power storage and the like for the purpose of effective use of electricity generated by photovoltaic power generation or electricity generated during night time, and at the same time, higher capacity thereof has been required.

In order to achieve higher capacity, it is essential to enlarge the area of electrode plates of the battery and to fill an active material in high density into a mixture layer, which is an electrode plate membrane. As a result, permeation of an electrolytic solution after placing the electrode plates in a battery housing needs longer time, and thereby decrease of its productivity is caused.

Thus, in order to solve such a problem, methods in which grooves are formed on the surface of the mixture layer to improve impregnation property of the electrolytic solution (for example, Japanese Patent Application Laid-Open Publication No. 2007-311328 and Japanese Patent Application Laid-Open Publication No. 2009-59686) or in which hollow porous particles are sprayed onto the surface of a mixture layer to form voids on the surface of the mixture layer, thereby to facilitate the permeation of the electrolytic solution (for example, Japanese Patent Application Laid-Open Publication No. 2005-228642) are offered.

### SUMMARY OF THE INVENTION

However, the prior arts as described above have following problems because a separator, which is a thin organic film for insulating a positive electrode and a negative electrode, is easy to be damaged. Therefore, when grooves on the mixture layer that is an electrode membrane constituted of an active material, a conductive auxiliary and a binder formed on both of the front and back surfaces of a metal collector foil of the electrode plate are formed, particles fallen off from the mixture layer penetrate the separator, and thereby an internal short circuit between the positive electrode and the negative electrode is caused. In addition, similarly, the hollow porous particles sprayed onto the surface of the mixture layer also damage the separator, and thereby an internal short circuit between the positive electrode and the negative electrode is caused.

The purpose of the present invention is to provide a lithium secondary battery having high reliability without damaging a separator as described above, and having excellent permeation property of an electrolytic solution into a mixture layer.

In order to prepare the above-described lithium secondary battery having excellent permeation property of the electrolytic solution into the mixture layer, it is only necessary that a portion of the mixture layer forms the mixture layer having large void size so that the electrolytic solution is easy to permeate.

More specifically, in order to solve the above-described problems, the present invention is characterized in that the mixture layer of the positive electrode membrane or the negative electrode membrane is constituted of a plurality of mixture layers having different void size, and the mixture layer has a first mixture layer having large void size and a second mixture layer having small void size as the mixture layers having different void size.

By constituting a mixture layer having large void size in the mixture layer, the electrolytic solution permeates into a mixture layer having small void size after firstly permeating into a mixture layer having large void size in a short period of time, and thereby the electrolytic solution can permeate into the mixture layer in a short period of time.

### BRIEF DESCRIPTION OF THE DRAWINGS

The present invention will become fully understood from the detailed description given hereinafter and the accompanying drawings, wherein:

FIG. 1 is a schematic view showing an electrode membrane structure according to one embodiment of the present invention in which a mixture layer having large void size is formed on the metal foil surface;

FIG. 2 is a graph showing a relationship between removal of fine powder and particle size distribution;

FIG. 3 is a schematic view showing a relationship between removal of fine powder and void size;

FIG. 4 is a graph showing a relationship between a removal amount of finer powder and a void amount;

FIG. 5 is a schematic view showing an electrode membrane structure according to one embodiment of the present invention in which a mixture layer having large void size is formed on the surface of a mixture layer having small void size;

FIG. 6 is a schematic view showing an electrode membrane structure according to one embodiment of the present invention in which a mixture layer having large void size is formed in the center part of a mixture layer having small void size in the thickness direction;

FIG. 7 is a schematic view showing a electrode membrane structure in which a mixture layer having large void size is formed inside of a mixture layer having small void size and the edge of the mixture layer having large void size is not exposed to the side face of the mixture layer having small void size;

FIG. 8 is a schematic view showing an electrode membrane structure according to one embodiment of the present invention in which a pattern of a mixture layer having large void size is formed as a grid pattern; and

FIG. 9 is a cross-sectional view of a lithium secondary battery according to one embodiment of the present invention.

### DETAILED DESCRIPTION OF THE PREFERRED EMBODIMENTS

Hereinafter, embodiments of the present invention will be described with reference to the accompanying drawings.

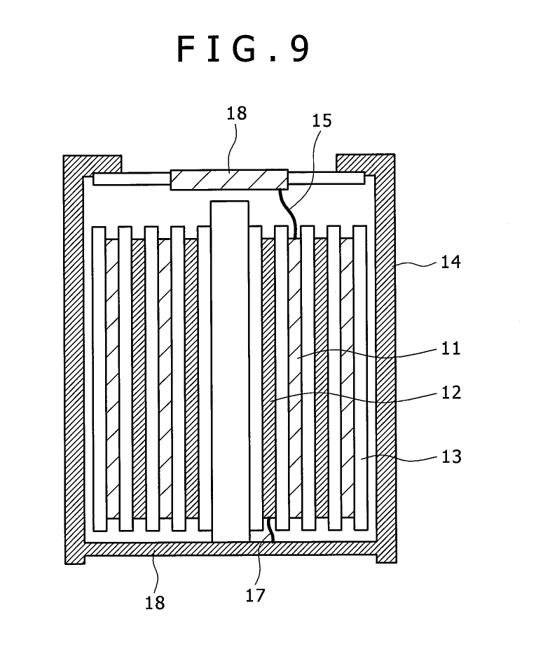

A cross-sectional schematic view of a lithium secondary battery of the present embodiment is shown in FIG. 9. The lithium secondary battery according to the embodiment is constituted of a positive electrode 11 having a collector at the side of the positive electrode (a positive electrode plate, not shown) and mixture layers at the side of the positive electrode (positive electrode membranes, not shown) formed on both sides thereof, a negative electrode 12 having a collector at the side of the negative electrode (a negative electrode plate, not shown) and mixture layers at the side of the negative electrode (negative electrode membranes, not shown) formed on both sides thereof, and an electric insulating layer 13 disposed between the positive electrode 11 and the negative electrode 12. These are placed inside of a container 14. The positive electrode 11 is connected to a positive electrode terminal 16 provided on the surface of the container 14 via a positive electrode wiring 15 and the negative electrode 12 is connected to a negative electrode terminal 18 provided on the bottom face of the container 14 via a negative electrode wiring 17.

The positive electrode 11 is prepared in a manner that a slurry that is made by dispersing and kneading lithium manganate, which is one of the lithium-transition metal complex oxides, as an active material, carbon powder as a conductive auxiliary and polyvinylidene fluoride (hereinafter abbreviated as PVDF) as a binder in 1-methyl-2-pyrrolidone (hereinafter abbreviated as NMP) is applied on the collector at the side of the positive electrode made of Al to form the mixture layer at the side of the positive electrode and dried.

The negative electrode 12 is prepared in a manner that a slurry that is made by dispersing and kneading carbon powder that can occlude and release lithium ion as an active material and PVDF as a binder in NMP is applied on the collector at the side of the negative electrode made of Cu to form the mixture layer at the side of the negative electrode and dried.

The electric insulating layer 13 having through-holes between the positive electrode 11 and the negative electrode 12 is prepared as follows. Among sheets used as a separator for the lithium ion secondary battery, a sheet of fine porous polypropylene sheet or polyethylene sheet is provided. These sheets act as the electric insulating layer. This sheet is hereinafter referred to as a separator.

It is necessary that this electric insulating layer 13 is a fine porous material having through-holes (not shown) in order that an electrolyte (not shown) may permeate and ion-conducting property may be maintained. The through-holes pass through from the positive electrode 11 to the negative electrode 12. From the viewpoint of permeation property of the electrolyte, a distance between the positive electrode and the negative electrode, and prevention of pass of detached electrode mixture particles, an average pore diameter of the through-holes is desirably 0.05-5 μm. During a manufacturing process of the battery, when the electrolyte is poured, inside of the through-hole is filled with the electrolyte, and thereby ions in the electrolyte can transfer between the positive electrode and the negative electrode.

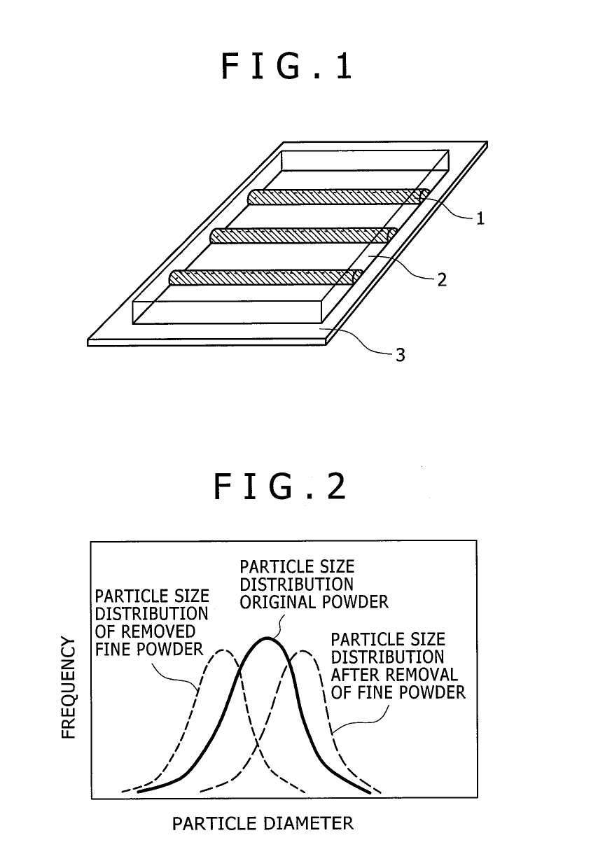

A collector foil (a positive electrode plate or a negative electrode plate) and mixture layers 1,2 formed thereon are shown in FIG. 1. Two structures thereof are provided and the separator is sandwiched between them, and the obtained structure is wound to form a wound body of the positive electrode/negative electrode/separator. The mixture layer has the mixture layer 1 having large void size and the mixture layer 2 having small void size.

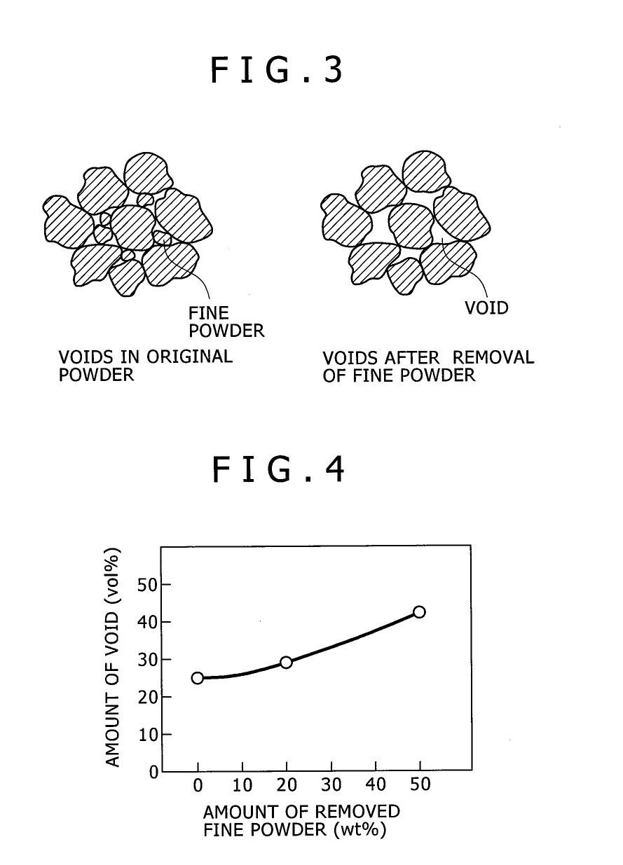

First, a method for forming the mixture layer 1 having large void size will be described. As shown in FIG. 3, particles forming the mixture layer 2 having small void size contain large powder and small powder that are mixed. Therefore, the void is small because the small powder enters into gaps of the large powder. Consequently, when small powder entering into a gap part, namely fine powder, is removed in order to enlarge the void size, the void size becomes large and permeation property of the electrolytic solution is enhanced.

Here, as a method for removing the fine powder, the fine powder may be removed by classification commonly performed for powder size control. As shown in FIG. 2, when the fine powder is removed by classification, particles having a larger average particle diameter than the original powder are generated. As an amount of the fine power removed, about 20 to 50% by weight of finer powder in the particle size distribution of the powder may be removed because the powder particle size that determines the void size after pressing in the electrode membrane is the powder particle size having approximately larger than an average particle diameter. The active material that has the highest amount in the electrode membrane mixture may be removed as the powder. Here, it is not preferable that the amount of the fine powder removed exceeds 50% by weight because the particle size becomes too large, and thereby a surface roughness of the mixture layer becomes too high, so that the mixture layer having predetermined thickness is difficult to form.

Change in a void amount when the fine powder is removed is shown in FIG. 4. When only an active material having an average particle diameter of 8 μm is used, a void amount is 25% by volume when the fine powder is not removed, 30% by volume when 20% by weight of the fine powder is removed and 45% by volume when 50% by weight of the fine powder is removed.

Here, an amount (by volume) of the mixture layer having large void size is 50% or less in the amount of the whole mixture layer. The reason is because a density of the active material of the mixture layer having large void size is lower than that of the mixture layer having small void size while the permeation rate of the electrolytic solution is high, so that the amount of the active material is decreased and a capacity of the battery becomes low when the amount of the mixture layer having large void size is increased. Consequently, in order to shorten the permeation time of the electrolytic solution when an amount of the mixture layer having large void size is low, a structure in which any region of the mixture layer having large void size is communicated with the edge face is formed and a liner (FIG. 1) or a grid (FIG. 8) pattern is preferable as a pattern shape when the mixture layer is constituted. The pattern in a longitudinal direction of the electrode plate may be an orthogonal directing or a leaning direction. In addition, a structure in communication with the edge in the surface direction of the mixture layer is convenient for permeating the electrolytic solution. Here, when the mixture layer having large void size is not pass through the two edges as shown in the drawings, the effect to shorten the permeation time of the electrolytic solution is sufficiently caused if the mixture layer having large void size is communicated with one edge.

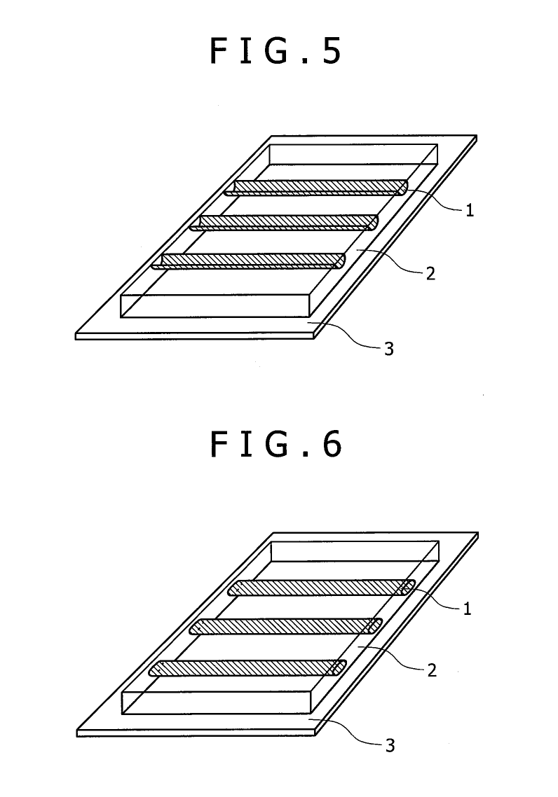

Moreover, this mixture layer having large void size may be formed on the surface of the collector foil of the electrode plate (FIG. 1), formed inside of the mixture layer having small void size (FIG. 6) or formed on the surface of the mixture layer having small void size (FIG. 5).

Here, when the mixture layer 1 having large void size is formed on the surface of the electrode plate collector foil 3 or the surface of the mixture layer, formation of the mixture layer 2 having small void size is performed at one time. However, when the mixture layer 1 having large void size formed inside of the mixture layer 2 having small void size, after forming the mixture layer 2 having small void size, the mixture layer 1 having large void size and subsequently the mixture layer 2 having small void size are formed. Namely, the formation of the mixture layer having small void size is performed more than once.

Moreover, the mixture layer 1 having large void size may have any one of or combination of the pattern formed on the foil surface of the electrode plate, the pattern formed inside of the mixture layer and the pattern formed on the surface of the mixture layer.

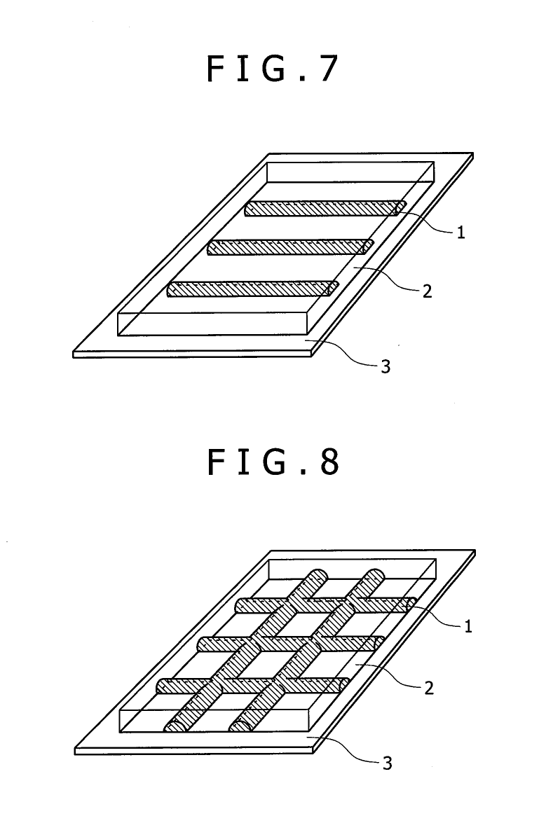

Here, when the mixture layer 1 having large void size is formed on the surface of the foil of the electrode plate or inside of the mixture layer 2 having small void size, a pattern edge of the mixture layer having large void size is preferably exposed at the side face part of the mixture layer having small void size. However, the pattern edge may not be exposed as long as the pattern edge of the mixture layer having large void size is located near the side face (FIG. 7).

The pattern as described above required for the mixture layer having large void size, for example, a pattern shape, a pattern width, a ratio occupied in the electrode area and a pattern thickness, has relation with the permeation time of the electrolytic solution into the mixture layer having small void size. More specifically, in the mixture layer having small void size, a permeated distance within a predetermined time T is defined as L when the electrolytic solution permeates from the edge of the mixture layer. When a distance from the mixture layer having small void size to all of the patterns of the mixture layer having large void size is within L, permeation to all of the mixture layers is terminated at about the time T. Here, the shorter the distance L, the shorter the time T.

However, when a ratio of the mixture layer having large void size becomes high, a capacity of the battery becomes low because the active material that can exist in the voids is decreased. Thus, it is better that the ratio of the mixture layer having large void size is low.

Methods for forming the mixture layer having small void size may be any common methods as long as a required pattern can be formed, and includes a die coating in which a material is extruded from a thin slit, a comma-reverse coating, a dispenser coating in which a material is extruded from a thin nozzle, a screen printing or the like.

In addition, the above-described mixture layer having large void size is preferably formed on both the positive electrode plate and the negative electrode plate. However, the mixture layers having large void size may be formed on one of the positive electrode plate and the negative electrode in which the electrolytic solution is difficult to permeate.

Here, it is natural that the positive electrode mixture and the negative electrode mixture are formed on both of the front and the back surfaces of the collector foil that is made of metal when the mixture layer having large void size is formed. This is because the electrolytic solution does not permeate into the collector foil.

### [Explanation of Each Example]

The method for forming the mixture layer having large void size according to the present invention is described above. Hereinafter, evaluation results of prepared lithium secondary batteries will be described based on the following Examples.

### Example 1

Here, the case in which the mixture layer having large void size is formed on the collector foils of both electrode plate of the positive electrode and the negative electrode will be described.

Between positive electrode membrane mixtures, a slurry of the mixture having small void size was prepared by the following method. Lithium-manganese-cobalt-nickel complex oxide powder, which is a lithium-transition metal complex oxide, as an active material was used. Powder sizes were an average particle diameter (D 50) of 5.8 μm, a 10% cumulative particle diameter (D10) of 2.6 μm and a 90% cumulative particle diameter (D90) of 12.3 μm. To 85 parts by weight of this lithium-manganese-cobalt-nickel complex oxide, 9 parts by weight of graphite powder as an electrically conductive material and 2 parts by weight of carbon black were mixed to prepare the positive electrode mixture. To this positive electrode mixture, a solution (a binder solution) of 1-methyl-2-pyrrolidone (hereinafter abbreviated as NMP) in which polyvinylidene fluoride (hereinafter abbreviated as PVDF) was dissolved to be 4 parts by weight was added and dispersed in NMP to form a slurry. At this time, a viscosity of the mixture slurry was 18000 cps.

Subsequently, between positive electrode membrane mixtures, a slurry of the mixture having large void size was prepared by the following method. The above-described active material of lithium-manganese-cobalt-nickel complex oxide was classified to remove 40% by weight of finer powder. At this time, powder sizes were an average particle diameter (D 50) of 8.4 μm, a 10% cumulative particle diameter (D10) of 5.3 μm and a 90% cumulative particle diameter (D90) of 16.1 μm. Similar to the method for preparing the slurry having small void size, to 85 parts by weight of this classified lithium-manganese-cobalt-nickel complex oxide, a binder solution was added so that 9 parts by weight of electrically conductive material, 2 parts by weight of carbon black and 4 parts by weight of PVDF were included, and NMP was mixed with adjusting viscosity to prepare a mixture slurry having a viscosity of 18000 cps.

Then, between negative electrode membrane mixtures, a slurry of a mixture having small void size was prepared by the following method. Amorphous carbon powder was used as an active material. Powder sizes were an average particle diameter (D 50) of 7.7 μm, a 10% cumulative particle diameter (D10) of 2.4 μm and a 90% cumulative particle diameter (D90) of 15.2 μm. To 93 parts by weight of this amorphous carbon, 2 parts by weight of carbon black was mixed to prepare the negative electrode mixture. To this negative electrode mixture, the binder solution was added so that 5 parts by weight of PVDF was included, and the product was dispersed in NMP to form a slurry. At this time, a viscosity of the mixture slurry was 8000 cps.

Subsequently, between negative electrode membrane mixtures, a slurry of a mixture having large void size was prepared by the following method. The above-described amorphous carbon powder was classified to remove 40% by weight of finer powder. At this time, powder sizes were an average particle diameter (D 50) of 11.3 μm, a 10% cumulative particle diameter (D10) of 5.2 μm and a 90% cumulative particle diameter (D90) of 19.3 μm. Similar to the above-described method, to 93 parts by weight of this classified amorphous carbon powder, a binder solution and NMP was mixed to prepare so that 2 parts by weight of carbon black and 5 parts by weight of PVDF are included, and a viscosity of the mixture slurry was adjusted to 8000 cps.

Electrode membranes of the positive electrode and negative electrode formed by using the above-described two types of positive electrode mixture slurries and two types of negative electrode mixture slurries will be described below.

First, preparation of the positive electrode plate will be described. A pattern of the mixture layer having large void size onto an aluminum collector foil is formed as follows. After the slurry of the mixture layer having large void size prepared as described above was applied by using a roll screen printing machine and dried to form a pattern having a width of 2 mm, a thickness of 40 μm and a pitch of 20 mm, the slurry of the mixture layer having small void size was applied onto the pattern of the mixture layer having large void size with a die coater and then dried to prepare an electrode membrane having a thickness of 70 μm made of the dried mixture layer having large void size and the mixture layer having small void size. Subsequently, the positive electrode plate was prepared by forming the pattern of the mixture layer having large void size also onto the back surface in a similar way, and then forming the mixture layer having small void size thereon. Here, a pattern edge of the mixture layer having large void size was exposed at a side face part of the mixture layer having small void size.

Then, preparation of the negative electrode plate will be described. A pattern of the mixture layer having large void size onto a copper collector foil is formed as follows. Similar to the positive electrode, after the slurry of the mixture layer having large void size was applied by using a roll screen printing machine and dried to form a pattern having a width of 2 mm, a thickness of 40 μm and a pitch of 15 mm, the slurry of the mixture layer having small size was applied onto the mixture layer pattern having large void size with a die coater and then dried to prepare an electrode membrane having a thickness of 80 μm made of the mixture layer having large void size and the mixture layer having small void size. Subsequently, the negative electrode plate was prepared by forming the pattern of the mixture layer having large void size also onto the back surface in a similar way, and then forming the mixture layer having small void size thereon.

Then, the positive electrode and the negative electrode was prepared by roller pressing with heating. Then, the above-described positive electrode and negative electrode sandwiched a fine porous separator made of polyethylene and wound spirally to prepare the electrode body. A lead is attached to this wound electrode body and the electrode body was inserted in a cylindrical container (a battery can) having bottom and having an outer diameter of 50 mm and a height of 170 mm.

Then, after inside pressure of the battery can into which the wound electrode body was inserted was reduced to vacuum, a non-aqueous electrolytic solution was poured therein, and after the solution permeated into the electrode mixture, a top lid was attached and the can was sealed to obtain a cylindrical lithium secondary battery.

A solution in which lithium hexafluorophosphate (LiPF₆) was dissolved in a solvent prepared by mixing ethylene carbonate (EC) and dimethyl carbonate (DMC) in a volume ratio of 1:1 at a concentration of 1 mol/l was used as a non-aqueous electrolytic solution.

At this time, a time required for permeation of the electrolytic solution was 380 seconds.

### Comparative Example 1

Here, a positive electrode plate and a negative electrode plate without formation of a mixture layer having large void size on a collector foil in Example 1 were prepared. A preparation method was similar to Example 1 except that a forming process of the mixture layer having large void size was not performed. For the positive electrode plate, the slurry of the mixture layer having small size was applied onto an aluminum foil with a die coater to prepare an electrode membrane having a thickness of 70 μm. Subsequently, the positive electrode plate was prepared by forming a mixture layer having small void size also onto the back surface in a similar way.

In addition, similar to Example 1, for the negative electrode plate, the slurry of the mixture layer slurry having small void size was applied onto a copper foil with a die coater to prepare an electrode membrane having a thickness of 80 μm. Subsequently, the negative electrode plate was prepared by forming a mixture layer having small void size also onto the back surface in a similar way.

Subsequently, after roller pressing with heating was performed, a wound electrode body was prepared and inserted into a battery can, and the non-aqueous electrolytic solution was poured and permeated. At this time, 980 seconds were required for permeation of the electrolytic solution.

### Example 2

In Example 1, the pattern of the mixture layer having large void size is set to a width of 2 mm, a thickness of 40 μm and a pitch of 20 mm. Here, the case in which a pattern is set to a width of 2 mm, a thickness of 40 μm and a pitch of 10 mm will be described.

The only difference to Example 1 was that a pitch of the mixture layer having large void size was 10 mm in Example 2 while the pitch was 20 cm in Example 1. A battery was prepared by a method in which other processes were similar to Example 1. When a time required for permeation of the electrolytic solution was measured, the time was 240 seconds.

### Example 3

The only difference to Example 1 was that a pattern of the mixture layer having large void size was a grid pattern which added a pattern having a width of 2 mm, a thickness of 40 μm and a pitch of 20 mm in parallel with the coating direction to a pattern having a width of 2 mm, a thickness of 40 μm and a pitch of 20 mm in perpendicular to the coating direction. A battery was prepared by a method in which other processes were similar to Example 1, and when a time required for permeation of the electrolytic solution was measured, the time was 190 seconds.

### Example 4

A pattern of the mixture layer having large void size was formed on the surface of the mixture layer having small void size. More specifically, the only difference to Example 1 was that the mixture layer having small void size was applied on the collector foil and dried before the mixture layer having large void size was formed on the surface thereof as a preparation method for the electrode plate. A battery was prepared by a method in which other processes were similar to Example 1, and when a time required for permeation of the electrolytic solution was measured, the time was 350 seconds.

### Example 5

The only difference to Example 1 was that a pattern of the mixture layer having large void size was formed in the inside portion of the mixture layer having small void size. A battery was prepared by a method similar to Example 1 except this difference.

Formation of the mixture layer into the inside portion was performed as follows. First, preparation of the positive electrode plate will be described. After the slurry of the mixture layer having small void size was applied on the aluminum collector foil with a die coater and dried, a pattern was formed by a roll screen printing machine using the slurry of the mixture layer having large void size and dried. The slurry of the mixture layer having small void size was applied again with the die coater and then dried to prepare an electrode membrane having the same thickness in Example 1 made of the mixture layer having large void size and the mixture layer having small void size. Similarly, the negative electrode plate was also prepared in the inside portion of the mixture layer having small void size by forming a pattern of the mixture layer having large void size. After preparation, a battery was prepared by a method similar to Example 1, and when a time required for permeation of the electrolytic solution was measured, the time was 390 seconds that was almost equal to the time in Example 1.

### Example 6

While the pattern edge of the mixture layer having large void size is exposed at a side face part of the mixture layer having small void size, the case in which the pattern edge is not exposed will be described here.

The only difference to Example 1 was that a pattern of the mixture layer pattern having large void size on the surface of the collector foil, namely the pattern having a width of 2 mm, a thickness of 40 μm and a pitch of 20 mm, did not protrude from the mixture layer pattern having small void size and a distance from the side face of the mixture layer pattern having small void size to a edge of mixture layer pattern having large void size was set to 2 mm. A battery was prepared by a method in which other processes were similar to Example 1. At this time, when a time required for permeation of the electrolytic solution was measured, the time was 390 seconds that is almost equal to the time in Example 1.

As described above, it is found that permeation property of the electrolytic solution can substantially improved by forming the mixture layer having large void size in a part of the mixture layer.

In addition, in the present embodiments, lithium-manganese-cobalt-nickel complex oxide is exemplified as a positive electrode active material of lithium-transition metal complex oxide. However, the present invention is not limited to this. Except for the present embodiments, for example, lithium-manganese complex oxide in the form of spinel crystal structure or mixture layer type crystal structure; materials in which a portion of manganese or lithium is substituted or doped by the other elements, for example, Fe, Co, Ni, Cr, Al, Mg or the like; materials in which a part of oxygen in the crystal is substituted or doped by elements such as S, P or the like are included. Similarly, in the present embodiments, the amorphous carbon powder is exemplified as the negative electrode active material. However, the present invention is not limited to this.

Furthermore, in the present embodiments, PVDF is exemplified as a binder. However, polytetrafluoroethylene (PTFE), polyethylene, polystyrene, polybutadiene, butyl rubber, nitrile rubber, styrene-butadiene rubber, polysulfide rubber, nitrocellulose, cyanoethylcellulose, various types of latexes, polymers of acrylonitrile, vinyl fluoride, vinylidene fluoride, propylene fluoride, chloroprene fluoride and the like and the mixture thereof can be included.

In addition, similarly, NMP is exemplified as the solvent. However, the present invention is not limited to this.

Moreover, the cylindrical battery made by winding the positive electrode, the negative electrode and the separator and enclosing the wound electrode body into the battery can is described as the structure of the battery. However, the present invention is applicable to a rectangular battery or a laminated battery that laminates the positive electrode and the like.

What is claimed is:

1. A lithium secondary battery comprising:
a positive electrode having a positive electrode plate and a positive electrode membrane formed thereon and being able to insert and eliminate lithium ion;
a negative electrode having a negative electrode plate and a negative electrode membrane formed thereon and being able to insert and eliminate lithium ion;
an electrolyte provided between the positive electrode and the negative electrode; and
an electrolytic solution permeated into the positive electrode membrane, the negative electrode membrane and the electrolyte,
wherein a mixture layer of the positive electrode membrane or the negative electrode membrane is constituted of a plurality of mixture layers having different void size.

2. The lithium secondary battery according to claim 1,
wherein: the mixture layer has a first mixture layer having large void size and a second mixture layer having small void size as the mixture layers having different void size; and
the first mixture layer exists inside of the second mixture layer and communicates with an edge in a face direction of the mixture layer.

3. The lithium secondary battery according to claim 1,
wherein the first mixture layer passes through between the facing two edges in the face direction.

4. The lithium secondary battery according to claim 1, wherein the plurality of mixture layers having different void size include different amounts of fine powder of an active material.

5. The lithium secondary battery according to claim 1,
wherein: the mixture layer has the first mixture layer having large void size and the second mixture layer having small void size as the mixture layers having different void size; and
the first mixture layer is a mixture layer removing finer powder of an active material of the second mixture layer.

6. The lithium secondary battery according to claim 3,
wherein the first mixture layer is provided as a stripe shape or a grid shape.

7. The lithium secondary battery according to claim 2,
wherein the first mixture layer is formed on the positive electrode plate or the negative electrode plate.

8. The lithium secondary battery according to claim 2,
wherein the first mixture layer is formed inside of the second mixture layer in a normal direction of the electrode.

9. The lithium secondary battery according to claim 2,
wherein the first mixture layer is formed on a surface part of the second mixture layer at the side of the electrolyte.

10. A manufacturing method for a lithium secondary battery including:
a positive electrode having a positive electrode plate and a positive electrode membrane formed thereon and being able to insert and eliminate lithium ion;
a negative electrode having a negative electrode plate and a negative electrode membrane formed thereon and being able to insert and eliminate lithium ion; and
an electrolyte provided between the positive electrode and the negative electrode,
the manufacturing method comprising the steps of:
forming a first mixture layer having large void size that forms the electrode membrane on the electrode;
forming a second mixture layer having small void size that forms the electrode membrane on the electrode;
providing the electrolyte between the two electrodes on which the first and the second mixture layers are formed; and
permeating an electrolytic solution into the electrodes and the electrolyte.

11. The manufacturing method for the lithium secondary battery according to claim 10,
wherein a material of the first mixture layer and the second mixture layer is the material having the same composition.

12. The manufacturing method for a lithium secondary battery according to claim 11,
wherein the manufacturing method further comprises the steps of:
classifying the material of the mixture layer into a particles having a large particle diameter and a particles having a small particle diameter;
forming the first mixture layer by using the particles having a large particle diameter; and
forming the second mixture layer by using the particles having a small particle diameter.
